(19) United States
(12) Patent Application Publication
(10) Pub. No.: US 2024/0371380 A1
(43) Pub. Date: Nov. 7, 2024

(54) SCALABLE AND IN-MEMORY INFORMATION EXTRACTION AND ANALYTICS ON STREAMING RADIO DATA

(71) Applicant: Genpact USA, Inc., New York, NY (US)

(72) Inventors: Rahul Saha, Asansol (IN); Siddharth Singh, Bangalore (IN); Jatindra Singh Deo, Bangalore (IN); Rajat Srivastava, Gujarat (IN); Gope Biswas, Bangalore (IN); Sreekanth Menon, Bangalore (IN)

(73) Assignee: Genpact Luxembourg S.à r.l. II, Luxembourg (LU)

(21) Appl. No.: 18/141,617

(22) Filed: May 1, 2023

(51) Int. Cl. G10L 17/14; G10L 17/02; G10L 25/63; G10L 25/78

(52) U.S. Cl. CPC G10L 17/14; G10L 17/02; G10L 25/63; G10L 25/78

(57) ABSTRACT

A method and system for processing an audio stream include receiving an audio stream by a node, splitting the audio stream into segments using a producer-consumer algorithm in the memory of the node, where the audio stream is split into the segments based on silence detection, transcribing voice included in a segment into text using a voice-to-text conversion engine, and performing natural language processing on the text to identify situational insights from the segment.

### TECHNICAL FIELD

This disclosure generally relates to the field of audio processing, and more particularly to scalable and in-memory information extraction and analytics on streaming radio data.

### BACKGROUND

Processing live voice streams in real-time remains a challenge, especially in building audio processing and/or analytical systems in fast-paced environments such as motorsports, customer support-related contact centers, etc. Under such fast-paced environments, there is a lot of live unstructured data available in the form of audio streams, such as HTTP live streaming (HLS), Web real-time communication (WebRTC) and the like, which may contain vital intelligence, and thus may be of key importance to improve the situational awareness of an ongoing process. For example, such vital intelligence may provide important guiding information and strategy for a race car driver during a race or post-race strategy analytics, or may offer significant insights to a customer support executive during a customer call. However, processing such HLS streams or other similar live unstructured audio information (such as WebRTC data and the like) near real-time remains a big challenge due to the latency (e.g., latency overhead in input/output from disk), which becomes more apparent in fast-paced environments, since the insights need to be derived near real-time so as not to lose relevance in the context of the situation awareness.

### SUMMARY

To address the aforementioned shortcomings, a method and system for scalable and in-memory information extraction from streaming audio data are provided. The method includes receiving an audio stream by a node, splitting the audio stream into segments using a producer-consumer algorithm in the memory of the node, where the audio stream is split into segments based on silence detection, transcribing voice included in a segment into text using a voice-to-text conversion engine, and performing natural language processing on the text to identify situational insights from the segment.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram of an example architecture for a real-time audio information extraction system, according to embodiments of the disclosure.

FIG. 2 is a block diagram of an example architecture for processing an audio stream, according to embodiments of the disclosure.

FIGS. 3A-3B collaboratively illustrate an example process for processing an audio stream using a producer-consumer algorithm, according to embodiments of the disclosure.

FIG. 4 illustrates an example audio processing worker architecture on an edge node, according to embodiments of the disclosure.

FIG. 5 illustrates an example pipeline containing an ensemble of speech analytics and text mining, according to embodiments of the disclosure.

FIG. 6 is a block diagram of an example computer for an audio processing system, according to embodiments of the disclosure.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

In motorsports, the vital moments in a race are short-lived, and information received within the bandwidth of a couple of seconds is mandatory for the insight to be useful. The inbound voice stream may include insights into race situations such as the position of the competing driver in the race, the health of the car, pit stops, fuel status, maneuvers to be shortly taken by competition, etc. Similarly, in contact center analytics, the customer care executive is in conversation with a customer and the executive has to judge the instant flow of the customer sentiment during the conversation. The existing solutions in audio processing and analytics do not meet the demands of these application scenarios due to the latency in data processing such as latency overhead in input/output (I/O) from disk or another storage device.

The technical solutions described in the present disclosure solve the above and other technical problems of the existing audio processing systems by providing a system design with an algorithm approach to consume, process, and store streaming HLS (or WebRTC and the like) data near real time, in terms of a conversation segment. For example, the latency achieved by the technical solutions disclosed herein may be about a length of a conversational segment, which is about three to five seconds or less.

According to one embodiment, in the audio processing methods and systems disclosed herein, conversational segments may be identified from an ingested live stream and processed in memory using an algorithm(s) included therein. For example, the ingested live audio stream may be split into conversation segments in memory to obtain small clips necessary for real-time audio processing. An in-memory producer-consumer algorithm may be included in the memory and implemented to split the audio stream into short conversational segments. In accordance with the disclosure, additional in-memory audio processing may include voice-to-text conversion and certain content filtration such as noise and irrelevant information removal, all of which may be implemented by using certain algorithms, including certain machine learning models trained for different purposes.

The audio processing methods and systems disclosed herein may show advantages over other existing audio processing systems. For example, as described earlier, the latency overhead in I/O from disk or another storage device in other audio processing systems may be greatly mitigated by in-memory processing disclosed herein. The mitigated latency overhead may push the audio processing closer to real-time processing. In addition, by filtering out unnecessary noise and/or irrelevant information, the data further broadcasted to subscribers may be minimized, which then saves the necessary bandwidth for publishing the insights to subscribers or other users. Additional benefits may include more immediate actions that can be taken due to the insights obtained near real-time. For example, due to the insightful information obtained from real-time audio processing, a customer service executive may be automatically provided with relevant answers to customer questions even without requiring the executive to search for such information. This additionally saves the time and resources used by the customer service system. For example, the executive at least does not need to perform an additional search.

It is to be noted that the benefits and advantages described herein are not all-inclusive, and many additional features and advantages will be apparent to one of ordinary skill in the art in view of the figures and the following descriptions.

### Overall Architecture

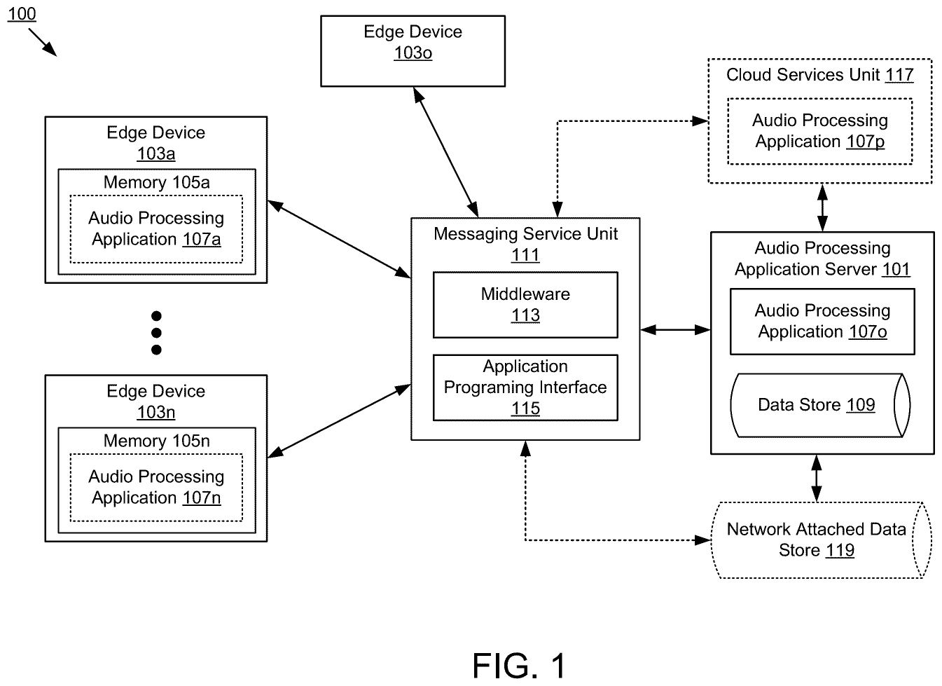

FIG. 1 is a block diagram of an example architecture for a real-time audio information extraction system 100, according to embodiments of the disclosure. Real-time audio information extraction system 100 may be a network-based specialized computer environment configured to process a large amount of audio data (or even video data), e.g., to extract insightful information from a live audio/video stream in real time. As illustrated in FIG. 1, the real-time audio information extraction system 100 may include one or more specialized computers or other machines that are configured to collect, process, transmit, and/or distribute data received by the system. For example, the real-time audio information extraction system 100 may include a Message Oriented Middleware (MOM) configuration that executes the passing of data between different applications and/or the associated hardware components. In another example, the real-time audio information extraction system 100 may include certain audio processing applications that have different layers of audio processing and further transmission, which may occur in different processing applications and/or the hardware components associated therewith.

As illustrated in FIG. 1, in one embodiment, the real-time audio information extraction system 100 may include one or more edge devices (or edge nodes) 103a . . . 103n (together or individually referred to as edge device 103 or edge node 103) that may receive and process an audio stream in memory 105a or 105n (together or individually referred to as memory 105). Memory 105 may further include an in-memory audio processing application 107a or 107n, which may process the received audio stream stored therein, e.g., splitting the received audio stream into conversational segments. As also illustrated in FIG. 1, the real-time audio information extraction system 100 may further include another audio processing application 107o in an audio processing application server 101, which may further process the split audio segments by identifying and analyzing the content in the split audio segments. Accordingly, there are different layers of audio processing by the disclosed audio information extraction system 100.

It should be noted that, while the audio processing application 107o is illustrated in the audio processing application server 101, in some embodiments, the audio processing application 107o may be actually located within a memory 105a or 105n. That is, the audio splitting and further processing may be all implemented in a same edge device 103a or 103n.

In some embodiments, when data is communicated between different layers of audio processing applications, the data transmission may be implemented through a messaging service unit 111, which may be a MOM messaging system for sending or receiving messages or data through messaging application programming interface (API). In some embodiments, the MOM messaging system may also send the information analyzed from the split audio segments to another edge device 1030, which may be a client device requesting such information, e.g., a downstream subscriber requesting such information. In some embodiments, the edge device 1030 may be the same or different from an edge device 103a or 103n. In one example, the edge device 1030 may not have an audio processing application 107. In another example, the edge device 1030 may also include a memory 105 and an audio processing application 107 included therein, and thus the information analyzed from the split audio segments may be returned to the same edge device, according to some embodiments. The specific details of each component included in a real-time audio information extraction system 100 are further provided hereinafter.

Edge device 103 may be configured to receive data in real time as part of a streaming analytics environment. In one embodiment, data may be collected using a variety of sources as communicated via different kinds of networks or locally. Such data may be received on a real-time streaming basis. For example, in some embodiments, edge device 103 may include an audio or video recording device that monitors their environment or other devices to collect data regarding that environment or those devices, and such network devices may provide data they collect over time. For example, edge device 103 may receive data from network devices or video or audio sensors as the sensors continuously sense, monitor, and track changes in their environments. In some embodiments, edge device 103 may also include devices within the internet of things (IoT), such as devices within a home automation network.

Edge device 103 may be configured to further implement audio processing applications on the data such as audio or video data it receives. For example, edge device 103 may be a computing device associated with a customer service executive and may receive an audio stream from an audio component included in and/or connected to the computing device, where the audio stream may be timely stored in the memory 105 of the edge device upon receipt. As described earlier, memory 105 may include an audio processing application 107 that may implement some layers of audio processing, e.g., splitting audio streams into conversational segments as described elsewhere herein. In another example, edge device 103 may be a device associated with a motorsports team, which may receive a live audio stream provided by a streaming service provider or another different entity. The edge device 103 under this application scenario may also include an audio processing application 107 configured for audio stream splitting and/or other downstream applications. Other edge devices for different purposes may be also possible (e.g., a device for a video game player). In general, edge device 103 disclosed herein may include a desktop computer, laptop, handheld or mobile device, personal digital assistant, wearable device, IoT device, network sensor, database, embedded system, virtual reality (VR)/augmented reality (AR) device, or another device that may process, transmit, store, or otherwise present audio data or related content.

In some embodiments, edge device 103 may be a part of distributed computing topology in which information processing (e.g., certain layers of audio processing) is located close to the edge where things or people produce or consume that information. Edge computing topology brings computation and data storage closer to the devices where it is being gathered, rather than relying on a central location that can be thousands of miles away. This is done so that data, especially real-time data, does not suffer latency issues that can affect an application's performance. In addition, the amount of data that needs to be sent to a centralized or cloud-based location is also reduced, which saves the bandwidth required by the applications.

In some embodiments, edge device 103 may communicate with other components of the system 100 through a data communication interface. For example, edge device 103 may collect and send data to the audio processing application server 101 to be processed therein (e.g., different layers of audio processing to be performed in the server), and/or may send signals to the audio processing application server 101 to control different aspects of the system or the data it is processing, among other reasons. Edge device 103 may interact with the audio processing application server 101 in several ways, for example, over one or more networks (not shown) and/or messaging service unit 111

In one embodiment, messaging service unit 111 may include one or more additional components configured for routing certain communications or data to respective parties. For example, messaging service unit 111 may include a middleware 113 for setting up communications with the edge device 103 and one or more application programming interfaces 115. The middleware 113 may be configured to allow software components that have been developed independently and that run on different networked platforms to interact with one another. For example, middleware 113 may be configured to allow different layers of audio processing application 107 installed on the same or different devices to interact with one another. Although not illustrated, the middleware 113 may reside between an application layer and a platform layer (e.g., an operating system and underlying network services). Applications distributed on different network nodes (e.g., edge node 103 and/or server 101) may use the application programming interface 115 to communicate without having to be concerned with the details of the operating environment that hosts other applications nor with the services that connect them to these applications. In some embodiments, the application programming interface 115 may further include an administrative interface, which may allow monitoring and/or tuning the performance of the messaging service unit 111. For example, the scale of the messaging service unit 111 may be increased or decreased without losing functions.

In some embodiments, real-time audio information extraction system 100 may further include one or more network-attached datastore 119. Network-attached datastore 119 may be configured to store data managed by the messaging service unit 111, the audio processing application server 101 as well as any intermediate or final data generated by real-time audio information extraction system 100 in non-volatile memory. In certain embodiments, the configuration of the messaging service unit 111 allows its operations to be performed such that intermediate and final data results may be stored solely in volatile memory, without a requirement that intermediate or final data results be stored to non-volatile types of memory, e.g., network-attached datastore 119. This may be useful in certain situations, such as when the real-time audio information extraction system 100 receives ad hoc queries from a user and when responses, which are generated by processing large amounts of data, need to be generated on-the-fly. In this non-limiting situation, the messaging service unit 111 may be configured to retain the processed information within memory so that responses may be generated for the user at different levels of detail as well as allow a user to interactively query against this information.

Network-attached datastore 119 may store a variety of different types of data organized in a variety of different ways and from a variety of different sources. For example, network-attached datastore 119 may store unstructured (e.g., raw) data such as audio streams, or structured data such as intermediate data processed from audio streams for machine learning (ML) model-based predictions or other analysis.

In some embodiments, real-time audio information extraction system 100 may additionally include an audio processing application server 101. According to some embodiments, audio processing application server 101 may be an edge server or edge gateway that sits between an edge device 103 and a data center (e.g. data store 109) or cloud (e.g., network-attached datastore 119) associated with an entity (e.g., customer service provider or a motorsports team). By configuring an edge server in the edge computing environment, data processing, transmission, and storage may be considered faster, enabling more efficient real-time processing of audio or video streams that are critical in customer services, motorsports, or other industries. To achieve such functions, an edge server may be equipped with algorithms for audio-related processing, such as text analysis, irrelevant information filtration, or other natural language processing functions. In some embodiments, an edge device may be not necessarily equipped with enough capacity to handle more complicated processing, and thus configuring an edge server close to edge devices may allow more complicated or computing-intensive processes to be performed in the edge server. For example, in a motorsports race, there may be a large number of audio channels corresponding to different drivers and associated engineers received by an edge device, which may be not able to handle crowd natural language processing (NLP)-related analysis in real-time, and thus an edge server with a more powerful computing resources may release such crowd data processing from an edge device to an edge server, which may then allow the insightful information to be extracted from the crowd NLP-related analysis in real-time.

In some embodiments, audio processing application server 101 may be separately housed from each other device within the real-time audio information extraction system 100, such as edge device 103, and/or may be part of a device or system, e.g., may be integrated with edge device 103 to form an integrated edge node. In some embodiments, audio processing application server 101 may host a variety of different types of data processing as part of real-time audio information extraction system 100, as will be described more in detail later. In addition, audio processing application server 101 may also receive a variety of different data from edge device 103, from cloud services unit 117, or other sources. The data may have been obtained or collected from one or more sensors, or may have been received as inputs from an external system or device.

In some embodiments, the real-time audio information extraction system 100 may additionally include one or more cloud services units 117. Cloud services unit 117 may include a cloud infrastructure system that provides cloud services. In some embodiments, the computers, servers, and/or systems that make up the cloud services unit 117 are different from a user or an organization's own on-premise computers, servers, and/or systems. For example, the cloud services unit 117 may host an application (e.g., an audio processing application 107p), and a user may, via a communication network, order and use the application on-demand. In some embodiments, services provided by the cloud services unit 117 may include a host of services that are made available to users of the cloud infrastructure system on demand. For example, the services provided by cloud services unit 117 may include machine learning model development, training, and deployment. In some embodiments, the cloud services unit 117 may be also a server for providing third-party services, such as messaging, emailing, social networking, data processing, image processing, or any other services accessible to online users or edge devices. In some embodiments, the cloud services unit 117 may include multiple service units that each is configured to provide one or more of the above-described functions or other functions not described above.

In some embodiments, services provided by the cloud services unit 117 may dynamically scale to meet the needs of its users. For example, cloud services unit 117 may house one or more audio processing applications 107p, which may be scaled up and down based on audio data to be processed by the disclosed system 100. In some embodiments, cloud services unit 117 may be utilized by the audio processing application server 101 as a part of the extension of the server, e.g., through a direct connection to the server or through a network-mediated connection.

Communications within the real-time audio information extraction system 100 may also occur over one or more networks (not shown), as described earlier. Networks may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks may include a short-range communication channel, such as Bluetooth or a Bluetooth Low Energy channel. A wired network may include a wired interface. The wired and/or wireless networks may be implemented using routers, access points, bridges, gateways, or the like, to connect devices in the system 100. One or more networks may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or transactional details may be encrypted (e.g., through symmetric or asymmetric encryption).

Some aspects may utilize the IoT, where things (e.g., machines, devices, phones, sensors) may be connected to networks and the data from these things may be collected and processed within the IoT and/or external to the IoT. For example, the IoT may include sensors in many different devices, and high-value analytics may be applied to identify insightful information and drive additional actions. This may apply to both big data analytics and real-time analytics.

The data store 109 may be coupled to the audio processing application 107o included in the server 101, and may be configured to manage, store, and retrieve large amounts of data that are distributed to and stored in one or more network-attached datastore 119 or other datastores that reside at different locations.

It should be noted that, while each device, server, and unit in FIG. 1 is shown as a single device, it will be appreciated that multiple devices may instead be used. For example, a set of messaging service units may be used to transmit various communications from a single user or different users, or audio processing application server 101 may include a server stack. As another example, data may be processed as part of messaging service unit 111. As yet another example, messaging service unit 111 may be a part of audio processing application server 101, and cloud services unit 117 and/or network-attached datastore 119 may be not included in real-time audio information extraction system 100.

In addition, the functions included in each instance of audio processing application 107a/107n/107o/107p (together or individually referred to as “audio processing application 107”) in different devices may be the same or different. In some embodiments, different instances of application 107 from different devices collaboratively complete one or more layers of audio processing. For example, one or more edge devices 103 and the audio processing application server 101 may collaboratively process an audio stream, where each instance of the application may perform a different layer of processes or functions. In the following, audio processing application 107 will be described further in detail with reference to specific engines, modules, or components, and their associated functions.

### Audio Processing Application

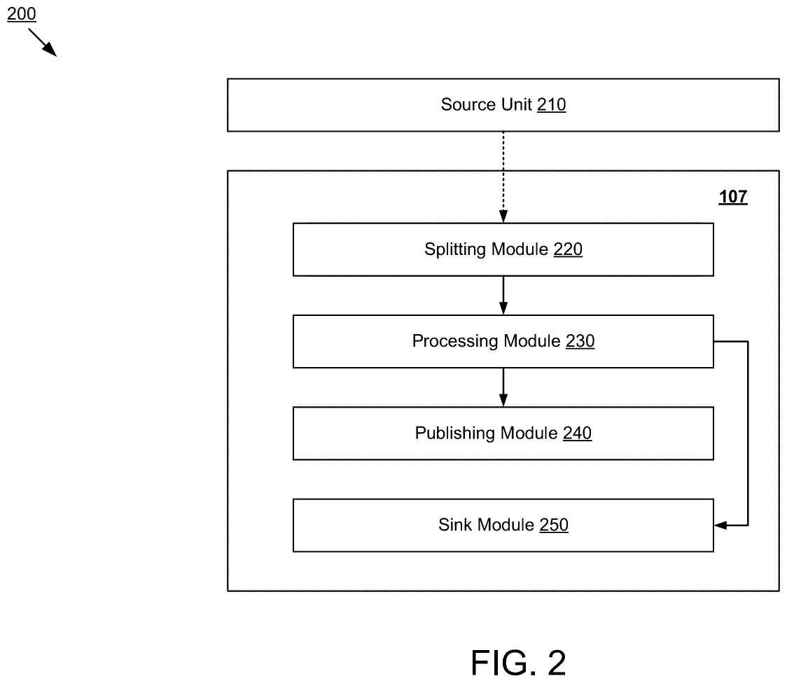

FIG. 2 illustrates an example architecture 200 for processing an audio stream, according to some embodiments. As illustrated, the architecture may include a source unit 210, for providing audio for processing, and a coupled audio processing application 107, for processing the audio provided by the source unit 210. The audio processing application 107 may further include a splitting module 220, a processing module 230, a publishing module 240, and a sink module 250.

According to one embodiment, the splitting module 220 may be configured to split the audio received from the source unit 210 into a plurality of conversational segments based on silence detection. The processing module 230 may be configured to further process the generated conversational segments, e.g., voice-to-text conversion of the conversational segments and further perform NLP analysis to identify the important messages or information from the conversational segments. The publishing module 240 may be configured to publish the identified information as messages through a pub/sub service. In some embodiments, the informant and/or messages identified from the conversational segments and the associated metadata may be further saved by the sink module 250 as a data sink. For example, the saved data may include a reference object for a data target (e.g., a subscriber or another different entity) that is external to the database. The data sink may include the location and connection information of the saved data to that external target. The specific functions of each module or unit in architecture 200 are further described in detail below.

The source unit 210 may be an edge component that generates and/or produces an audio stream. In some embodiments, the source unit 210 may further prepare an audio stream for transmission. The audio stream may be a live audio stream occurring in a paced environment. In one example, the audio stream may be an HLS (or WebRTC and the like) live audio stream. Under certain circumstances, there may be one audio stream (e.g., a customer service conversation) generated or produced by the source unit. In other conditions, there may be multiple audio channels in single or multiple audio streams provided by the source unit. For example, for motorsports such as the F1 formula race or NASCAR race, there may be multiple audio channels for communications between different drivers and their assisting engineers. Accordingly, in some embodiments, the disclosed real-time audio information extraction system 100 may be configured to process a large-scale audio stream near real time.

It should be noted that while only the audio stream is described herein, in some embodiments, the source unit 210 may also generate and/or produce a video stream. Under such circumstances, the source unit 210 may further include an audio extractor configured to extract an audio stream from the received video stream in real time so that only audio data is provided by the source unit 210 to the audio processing application 107. In some embodiments, an audio extractor may be included in the audio processing application 107 and thus the corresponding audio extraction may be performed in the audio processing application instead.

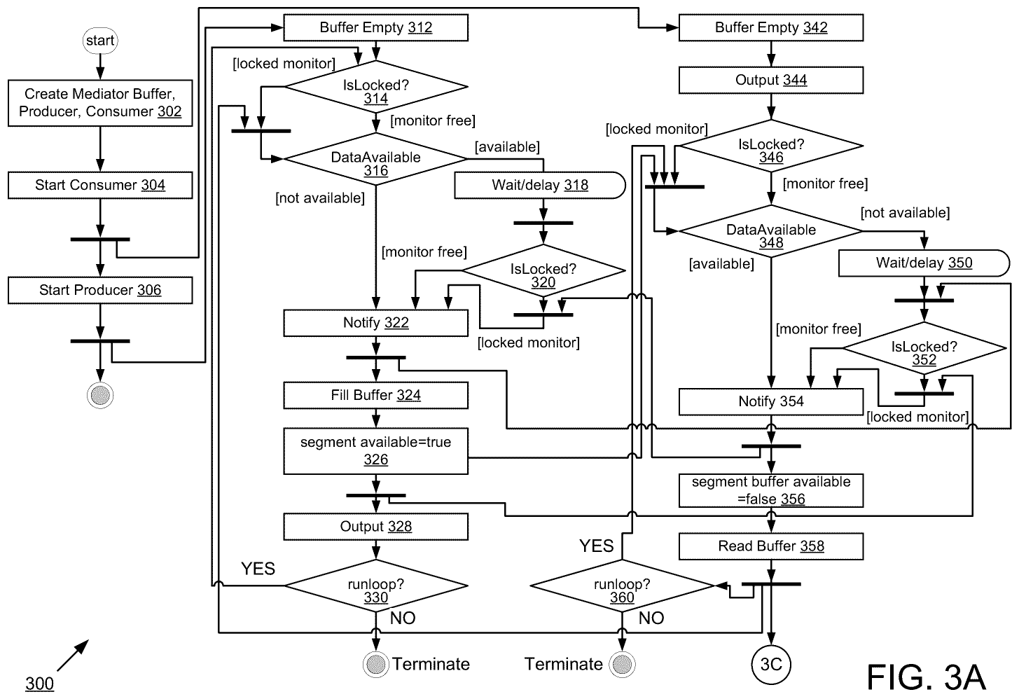

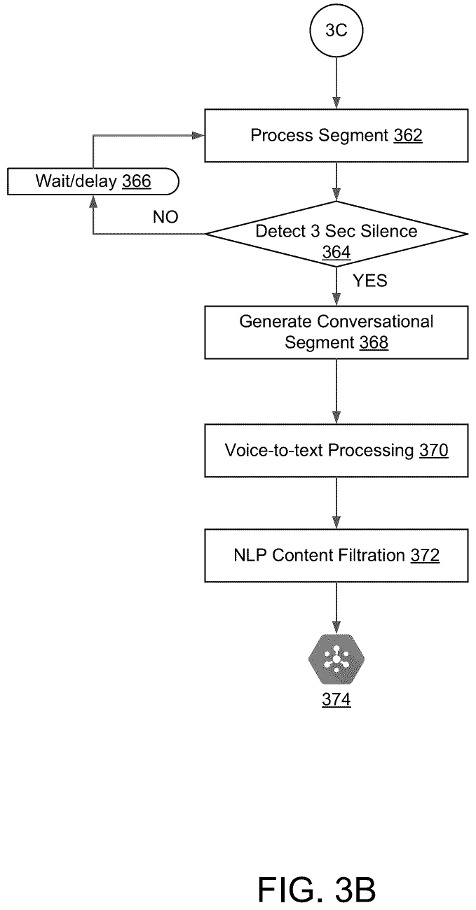

The splitting module 220 may be configured to split an audio stream received from the source unit 210 into chunks of audio blocks. One of the reasons to split data into audio blocks or chunks is that the processing of the smaller audio blocks (e.g., conversational segments) allows the insightful information to be obtained instantly after processing each smaller audio block, but not the processing of a longer audio stream. Another reason to use audio blocks or chunks instead of a continuous stream flow for audio processing is that it would be more efficient to identify and discard chunks of noise. For example, if a continuous stream flow of audio data is presented for processing, it would be difficult to discard the whole stream flow if there are both noise and valuable sections in the whole stream flow. Accordingly, by chunking and further discarding certain chunks containing irrelevant information (e.g., white noise, long or short silence), it may minimize the data for transmission and/or further processing, thereby increasing the efficiency of the disclosed real-time audio information extraction system 100. In addition, as described earlier, to mitigate the latency overhead in I/O (e.g., input/output from disk), an in-memory producer-consumer mode may be implemented. Since in-memory processing generally takes action on data entirely in computer memory (e.g., in RAM), the limited processing capacity in memory may also favor processing smaller chunks of audio data instead of a whole flow of an audio stream, to avoid a possible crash. The specific processes for splitting an audio stream into audio chunks (e.g., conversational segments) are further described in detail in FIG. 3.

The processing module 230 may be configured to process the audio chunks such as conversational segments split by the splitting module 220. In some embodiments, the conversational segment processing may include a voice-to-text conversion process and a following NLP analysis. Specifically, for voice-to-text conversion, the processing module 230 may employ a voice-to-text converter that automatically transcribes voice in the conversational segments into text for further analysis. The voice-to-text converter may be an AI-supported converter that includes algorithms configured to pick the sounds of a conversational segment, measure audio waves, and analyze the waves (e.g., no wave for a period of silence). Each sound may be matched with the phenomes of the English language or another different language if that is the language used in the audio stream. The next step is running the phenomes through mathematical models to transcribe them into known words, phrases, and sentences.

In some embodiments, the processing module 230 may further include an automated translation engine, which is configured to automatically translate text or voice from one language to another language. For example, for motorsports, there may be more than one language spoken in a race and recorded in the corresponding audio streams. A translation engine included therein may allow insightful information to be obtained even if the drivers speak different languages.

In some embodiments, the converted text may be further analyzed through NLP, which combines computational linguistics rule-based modeling of human language with statistical, machine learning, and deep learning models. Together, these technologies may enable the processing module 230 to process human language in the form of text or voice data and to understand its full meaning, complete with the speaker's intent and sentiment. For example, the NLP may classify the conversational segments into different categories based on the importance of the transcribed text from the conversation segments. In some embodiments, the NLP processing may also include filtering out irrelevant segments and/or text based on the understanding of the transcribed text. For example, small talks irrelevant to motorsports may be filtered out by the processing module 230.

The publishing module 240 may be configured to perform pub/sub services for the disclosed audio system. Pub/Sub is an asynchronous and scalable messaging service that generally decouples services producing messages. Pub/Sub allows services to communicate asynchronously, with latencies on the order of 100 milliseconds. Pub/Sub may be used for streaming analytics and data integration pipelines to ingest and distribute data. The publishing module 240 may communicate with subscribers asynchronously by broadcasting processed text. For example, the publishing module 240 may send text converted from the important conversational segments (also referred to as “important messages”) to all the services that react to them. This may include sending important messages to the respective parties for monitoring a race in motorsports, or to an executive that is in charge of customer communication. In systems communicating through RPCs, publishers must wait for subscribers to receive the data. However, three is no such requirement in the Pub/Sub service, and the asynchronous integration in Pub/Sub increases the flexibility and robustness of the disclosed audio processing system.

The sink module 250 may be configured to save processed intermediate data and final data into a sink for retrieval by interesting entities. Data sinks perform no function by themselves but act as proxies for transmitting data when referenced as a destination in the creation of a table monitor. In some embodiments, the sink module 250 may employ a series of API endpoint calls to manage data storage and/or retrieval. For example, the sink module 250 may create a data sink including location and connection information of the saved data, grant permission for a user (e.g., a team member in a motorsports race) to connect to a data sink, or remove the permission for a user to connect to a data sink for data access (e.g., prevent another team member from accessing the processed insights).

It should be noted that the above components or modules included in an audio processing application are provided for illustrative purposes and not as limitations. In some embodiments, the disclosed audio processing application may include additional components or modules and the corresponding functions associated therewith. In addition, some modules described separately may be integrated into a single module. The specific functions of the splitting module are further described in detail below.

### Part 1: Producer-Consumer (Splitting Module)

FIGS. 3A-3B collaboratively illustrate an example process 300 for processing an audio stream using a producer-consumer algorithm, according to some embodiments. In producer-consumer-based processing, the producer is a cyclic process, where each time it goes through its cycle, it produces a certain portion of information (e.g., the earliest portion of the live stream) that has to be processed by the consumer. The consumer is also a cyclic process, where each time it goes through its cycle, it can process the portion of the information that has been produced by the producer. During the data processing, the producer and consumer share a common memory buffer (also referred to as a “mediator buffer”). This buffer is a data storage space in the memory of the edge node. The producer produces the data into the mediator buffer and the consumer consumes the data from the mediator buffer. According to some embodiments, the producer may not produce any data when the shared buffer is full, and the consumer may not consume any data when the shared buffer is empty. The access to the shared buffer is expected to be mutually exclusive, i.e., at a time only one process may be able to access the shared buffer and make changes to it. The specific process of a producer-consumer algorithm for processing an audio stream is further described in detail below.

As illustrated in FIG. 3A, there is a main process for processing an audio stream using a producer-consumer algorithm, according to some embodiments. The main process may start with a creation of a mediator buffer, a producer thread, and a consumer thread at step 302. The exact size of the created mediator buffer may vary depending on specific applications. In one example, the size of the mediator buffer may be determined based on the bitrate of an inbound stream, and/or the processing capacity of the system in producer-consumer operations. A higher bitrate of the inbound audio stream may require a larger mediator buffer, while a smaller buffer size may be sufficient for an audio stream with a low bitrate. If the bitrate of the inbound audio stream changes during the processing of an inbound stream, the buffer size may be also dynamically adjusted, to save the limited sources in the in-memory processing facility. In addition, under certain circumstances, there may be more than one mediator buffer generated if necessary. For instance, for an audio stream with extremely high bitrate or for multi-channel audio streams, more than one mediator buffers may be generated on the fly.

Just like images vary in quality and clarity, audio streams differ in quality and how much information they contain, and what role they fill. While there are some exceptions, uncompressed audio streams generally contain the most information and therefore have the highest bitrate, while compressed audio streams generally have the least amount of information and therefore a lower bitrate. By adjusting the buffer size or even the number of mediator buffers, it may allow the disclosed splitting module to accommodate different application scenarios.

Referring back to FIG. 3A, consumer process 304 and producer process 306 may follow the creation of the mediator buffer, the consumer thread, and the producer thread. The consumer process and produced process may be implemented alternatively. For example, when the buffer is empty, the producer thread may begin to chunk audio stream into the buffer by taking a certain amount of audio data (e.g., the earliest portion(s) of an audio stream) and processing the portion of the audio stream into the buffer. At this point, the buffer may be locked to the producer thread. When the buffer is full, the consumer thread may be notified and the lock is passed to the consumer thread. The consumer thread may consume the data in the buffer until the buffer is empty, at which point, the lock may be passed back to the producer thread.

Specifically, for the producer thread, in the beginning, the buffer may be empty at step 312. The producer thread may find that the buffer is locked or monitor-free at step 314, since the buffer may be just emptied by the consumer thread, and the lock may be not passed to the producer thread. When the buffer is monitor-free, the producer thread may further check whether there is data available (e.g., whether there is an audio stream for processing) at step 316. If there is no data available, the producer thread may notify the consumer thread that no data is available for further processing, and the audio process may end. If there is data available, the producer thread may wait/delay at step 318, to make sure that the buffer is locked to the producer thread at step 320. At this point, a notification may be sent to the consumer thread at step 322 to inform that the buffer is not available to the consumer thread. The producer thread may then fill the buffer at step 324, e.g., by chunking the earliest portion of the audio stream (also referred to as “audio block” or “audio clip”). The size of the audio block may be determined based on the detected bitrate in an adaptive way. For example, the higher the bitrate, the shorter the audio block is. After filling the buffer, there will be a segment available, as indicated by block 326. An output value may be generated at step 328 to indicate that the buffer is filled with segments. The output value may indicate a percentage of the buffer that remains available (e.g., 80% left, 60% left, 40% left, 20% left, etc.). Based on the output value, a runloop operation may be further performed at step 330, e.g., to fill the buffer with more audio data (e.g., an updated carliest portion of audio stream) if the audio stream is still available. However, if the buffer is full based on the output value at step 238, the result from the runloop operation may instead lock the buffer at step 314. At this point, the audio data is not accessible anymore at step 316, and the consumer thread is notified at step 322 to indicate that the buffer is ready for consumption. The consumer thread may then obtain the lock and begin to consume the data in the buffer.

For the consumer thread, when the buffer is empty at step 342, it may indicate that the consumer thread has consumed the data in the buffer. Accordingly, an output value may be generated at step 344 to indicate that the buffer is empty. The buffer may be still locked at step 346, and there is no data available at step 348. The consumer thread may then wait/delay at step 350 to ensure the buffer is ready to be passed to the producer thread, and then unlock the buffer at step 352 to release the buffer to the producer thread. A notification may be sent at step 354 to inform the producer thread that the buffer is released from the consumer thread. On the other hand, if the buffer is not empty and the data is available at step 348 (e.g., based on the status of “segment available=true” from block 326), the consumer thread may notify the producer thread that the buffer is locked to the consumer thread. Accordingly, the buffer is not available to the producer thread, as indicated by the “segment buffer available=false” in block 356. The consumer thread may then read the buffer at step 358, and further process the audio block read from the buffer at step 362, as further illustrated in FIG. 3B. Similar to the producer thread, the consumer thread may also has a runloop operation at step 360, which is configured to check whether there is still audio stream available in the buffer each time after reading the buffer at step 358. If there is no audio stream available, the operation by the consumer thread may terminate. At this moment, the buffer is empty, and an output value may be generated to indicate that the buffer is empty.

Referring to FIG. 3B, processing the audio blocks in the consumer thread may include detecting 3 seconds (or 2 seconds, 2.5 seconds, 3.5 seconds, or another different value) of silence at step 364, e.g., by comparing a detected silence to a predefined threshold (which can be 3 seconds or another different value) or a dynamically updated value, e.g., based on habits of the speakers identified from the audio blocks. Some speakers may speak quicker and thus have shorter gaps after other people speak during conversations, while other speakers may have longer gaps.

When detecting the silence, if there is no defined period of silence detected, the consumer thread may wait/delay at step 366 and continue to process the data read from the buffer. On the other hand, if the defined silence is detected, the chunked audio block may be demarcated at the detected silence position to generate conversational segments at step 368. In some embodiments, padding may be further performed on the demarcated conversation segments in creating an audio clip for downstream consumption. For example, the generated conversation segments may be then subject to a voice-to-text conversation at step 370 and the NLP content filtration at step 372. The filtered conversational segments may be then sent to the pub/sub service unit 374 for message communication, e.g., broadcasting to subscribers.

### Part 2: Worker Architecture

In the above-described embodiments, an exemplary process for processing an audio stream is described. However, in real applications, such as in a motorsports race, there may be a plurality of radio communications between drivers and engineers at the same time, all of which may include treasure troves of insights and thus may be critical to a team participating in the race. Accordingly, in the present disclosure, a worker-based architecture may be configured to allow to scale-up of the disclosed audio processing application to handle a high number of channels of inbound audio stream(s).

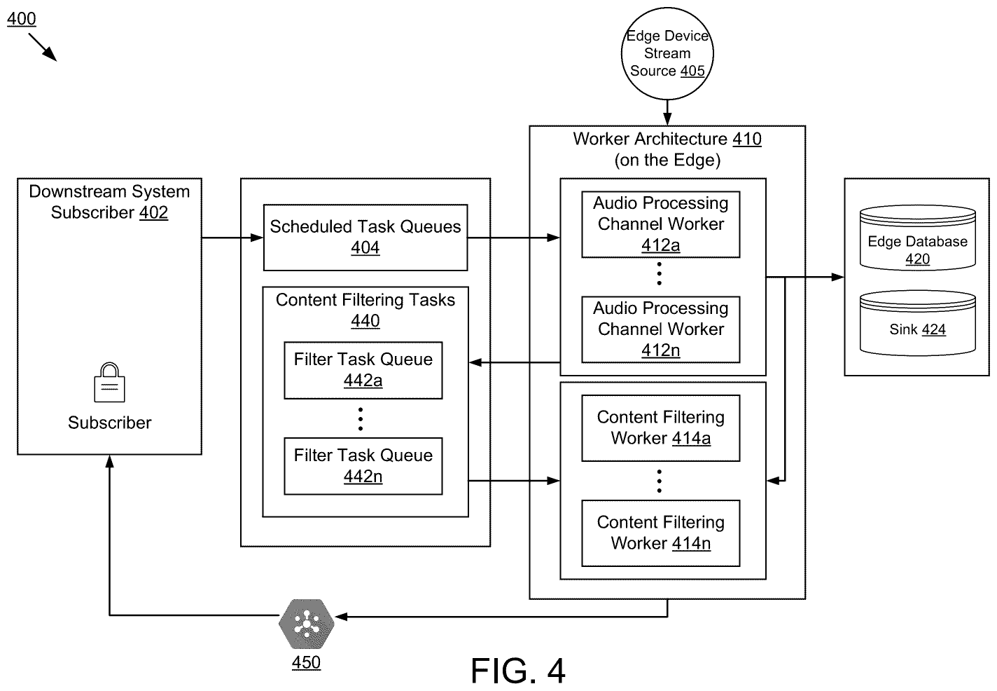

FIG. 4 illustrates an example audio processing worker architecture 400 on the edge node, according to some embodiments of the disclosure. As illustrated, the work architecture 410 may include a plurality of audio processing channel workers 412a . . . 412n (together or individually referred to as “audio processing channel workers 412” or simply “audio processing workers 412”) and a plurality of content filtering workers 414a . . . 414n (together or individually referred to as “content filtering worker 414”). Here, each worker 412 or 414 may refer to a background process configured to handle a certain number of tasks independent of each other and a main process (e.g., a process for assigning tasks to different workers). Here, a task may refer to a unit of computer logic encapsulating the producer-consumer approach to audio stream processing. For example, in the multi-channel audio streaming environment in motorsports, a task may refer to a unit of computer logic for processing a single channel of audio stream, which may include respective producer thread, consumer thread, and error thread for processing a single channel of streaming data. Here, an error thread may handle certain errors found during the audio processing. It is to be noted, while not described, an error thread may be also included in processing a single channel of audio stream described earlier in FIG. 3.

In some embodiments, by implementing a worker architecture, the disclosed audio processing system may be configured to dynamically scale up and down to process different numbers of channels of inbound audio stream based on the different application scenarios. For example, if there are “k” number of requests received by the worker architecture and if each worker may handle “m” tasks, a roundup value of “k/m” (which may equal to “n”) of workers may be created in the worker architecture to perform the received task requests. Here, each worker may handle the “k/n” number of tasks.

FIG. 4 further illustrates an example process for handling multiple tasks using a worker architecture, according to some embodiments. The process may start from a downstream system subscriber 402, which may schedule task requests for audio processing. In one example, the downstream system subscriber 402 may be a race monitoring system associated with a team or a driver in a motorsports race. The race monitoring system may listen to the radio communications between drivers and engineers during the race. Since multiple radio communications may occur simultaneously, it may be difficult to follow each radio communication well during the race. Accordingly, the downstream system subscriber 402 may schedule certain task requests to request to process all or portions of radio communications (e.g., all competitors or some specific competitors in the race) through the worker architecture 410. Scheduled task queues 404 may be thus generated, which may be further pushed to the worker architecture 410 on the edge node. The worker architecture 410 may then listen to the edge device stream source 405 and process different channels of radio communications from the edge device stream source 405. The audio processing channel workers 412 may then process the different channels of radio communications using a producer-consumer algorithm as described earlier. For example, each audio processing channel worker 412 may process tasks associated with one channel of radio communications using a producer-consumer algorithm to generate a series of conversational segments.

For each processed radio communication, for example, one or more conversational segments generated for such radio communication, further noise filtration may be necessary. For example, there may be certain white noise between detected silence periods. The white noise may generate sound wave, and thus may be detected as signals during silence detection, and thus while noise-containing conversational segments may be generated. Accordingly, the content filtering tasks 440 may be generated for the processed conversation segments. Since there are multiple audio processing channel workers 412a that work simultaneously, multiple filter task queues 442a . . . 442n (together or individually referred to as “filter task queues”) may be generated. Such generated filter task queues 442 may be pushed to content filtering workers 414, which may be also in the form of worker architecture and can process content filtration for multiple conversational segments in parallel. The conversational segments may be passed from an audio processing channel worker to a corresponding content filtering worker for content filtration. The exact content filtering worker selected for processing a conversational segment may be determined based on the filter task queues 442.

In some embodiments, the segmented conversational segments (or binary clips) and/or associated metadata may be also saved in the edge database 420 or sink 424. The edge database 420 may be a SQL database that stores and organizes data in tables, which are convenient for later analysis. When saving data to the sink 424, the location information and connection information for the saved data may be also generated, which allow data consumers to grab the data stored therein. For example, other teams in a motorsports race or certain other parties may be also interested in these processed conversational segments.

For the filtered conversational segments, they may be pushed to Pub/Sub 450 for further publishing to appropriate entities.

### Part 3: Analytics Processing Component

In some embodiments, the disclosed audio processing system may configure a specialized analytics processing component for contextual filtration. This contextual filtration may be different from noise filtration described earlier. For example, the contextual filtration may be based on the meaning of the transcribed text instead of sound wave signals, and is mainly used to filter out irrelevant chatter based on the analysis of the transcribed text.

In some embodiments, the analytics processing component may be an AI/ML-driven filtering model that includes a context filtering layer for contextually filtering irrelevant chatter. For example, some chatter from the conversational segments may be more related to personal communications or small talk that are not directly related to a focused topic, such as race or customer service. The AI/ML-driven filtering model may be trained with topic-related texts and topic-unrelated text, which may allow it to separate unrelated text from related text, thereby allowing filtering out irrelevant chatter once trained.

In some embodiments, the filtered context may be passed on upstream for real-time motorsport strategic input or a contact center agent dashboard for presentation or display, depending on the contextual usage of the analytics sub-system. In some embodiments, the filtered context may be subject to additional analysis before being passed on upstream. In one example, importance-based classification may be performed for the filtered context, so that only the transcribed text with an importance level beyond a predefined threshold level may be passed upstream. In another example, in an application scenario such as contact center analytics subscribing to the downstream audio processing system, an AI component may be further included to extend the existing analytics catalog by adding emotion/sentiment analysis, as will be described more in example applications below.

### EXAMPLE APPLICATIONS

### Example 1: Motorsports Analytics on the Edge

Motorsports analytics system disclosed herein is a fast-paced, real-time setup where messages from the radio conversations may be processed and analyzed in real-time to quickly take strategic decisions on a further course of action. Motorsports racing has been a testbed for high-performance computing and IT to generate insights and plot strategies in real-time. In the motorsports analytics system disclosed herein, a data channel for voice streams may be added on the edge to bring down latency, which may be combined with additional data channels such as timing feed and competitor time gap to enrich the transcribed data with additional context/dimension to the conversation relative to the live race situation. For example, important messages may be instantly identified from the voice streams by the disclosed sports analytics system, which provides insightful information in real-time in a race.

The motorsports analytics system may include a worker architecture on the edge, as described in FIG. 4. For example, the motorsports analytics system disclosed herein may include a set of audio processing channel workers and a set of content filtering workers configured to process the radio conversations, so as to obtain a transcribed stream of messages, which can be further processed to identify relevant or important messages, as described in the following.

In general, radio messages from motorsports are not simple conversations. These radio messages are short, sometimes encoded, and mostly free from stop words. For example, “multi-21” is an encoded message that has been used to tell the affiliated drivers in what order they should finish the race in. All of these features of radio messages make it difficult to analyze these messages as a typical NLP problem. The message processing of the transcribed stream of messages disclosed herein thus plays an important role in motorsports, as it provides a reasonable form to an otherwise complex understanding of the stream of messages.

According to one embodiment, the transcribed message processing may include identifying codes (e.g., domain-specific codes such as “multi-21”) from normal words, decoding the identified codes to obtain relevant information, and reframing the message with only relevant words. In some embodiments, a database may be established for the encoded message, which may be used to decode the coded portions in messages.

In some embodiments, the disclosed motorsports analytics system may further include a classifier that is built using an M*N encoded matrix. Each column in the matrix may represent a word, and each row may represent a message. This matrix may be different from one-hot encoding. as the encoded matrix also assumes weights for each word. These weights may be calculated based on the frequency and/or order of occurrence in relevant and irrelevant messages. For example, the words with higher frequency may be considered to be more relevant, and thus have greater weights. Similarly, due to the short messages in fast-paced environments, more important words may occur first, and thus the words that occur earlier in the messages may have greater weights. For example, for the message “Speed up, number 8 is approaching,” the words “speed up” may have greater weights than the other words in the message.

In some embodiments, the classifier may be further trained using a machine learning approach to identify more important words and then assign such words with greater weights. Both supervised approaches and unsupervised approaches may be applied to train the classifier. For supervised training, a list of words may be identified as “highly important” by the race strategists and used in the training process. Accordingly, a supervised classifier may be trained using the re-structured dataset. In some embodiments, the supervised classifier may be further tuned to handle highly imbalanced classes. In some embodiments, certain unsupervised context-dependent approaches may be applied for vocabulary speech recognition.

In some embodiments, by utilizing the machine learning-based classifier for word categorization of the transcribed messages, useful insights may be generated from the audio messages in real-time, thereby giving an upper hand to the team against the competitors. For example, the classifier may categorize the messages into different categories with different importance, such as “high importance,” “medium importance,” “low importance,” “no importance,” and so on. The motorsports analytics system may then forward the messages with certain importance levels (e.g., high importance and/or medium importance) for attention. In this way, the disclosed motorsports analytics system can generate useful insights from the radio messages in real-time (e.g., in terms of a conversational segment), which can thus give an upper hand to a team against the competitors in a race.

From the above, it can be seen that during a motorsports-related race, using the disclosed motorsports analytics system, a team may quickly process each recorded radio stream into relevant clips. In some embodiments, even without the necessity to trim the silence from the audio, the team may quickly catalog clips by driver and race. This makes it easier to gain quick insights into how rivals are approaching challenges, including when they might take to the pit, how they manage remaining energy, and when they are likely to use attack mode (which is an extra boost of energy available to all drivers during the race). By introducing natural language processing to the disclosed motorsports analytics system, the team may also automate clip sorting quickly enough to access insights and intelligence during a race. With more detailed competitive knowledge, drivers in the team may make better in-race decisions, and improve overtaking and defensive strategies, thereby changing the outcome of a race.

### Example 2: Contract Center Analytics

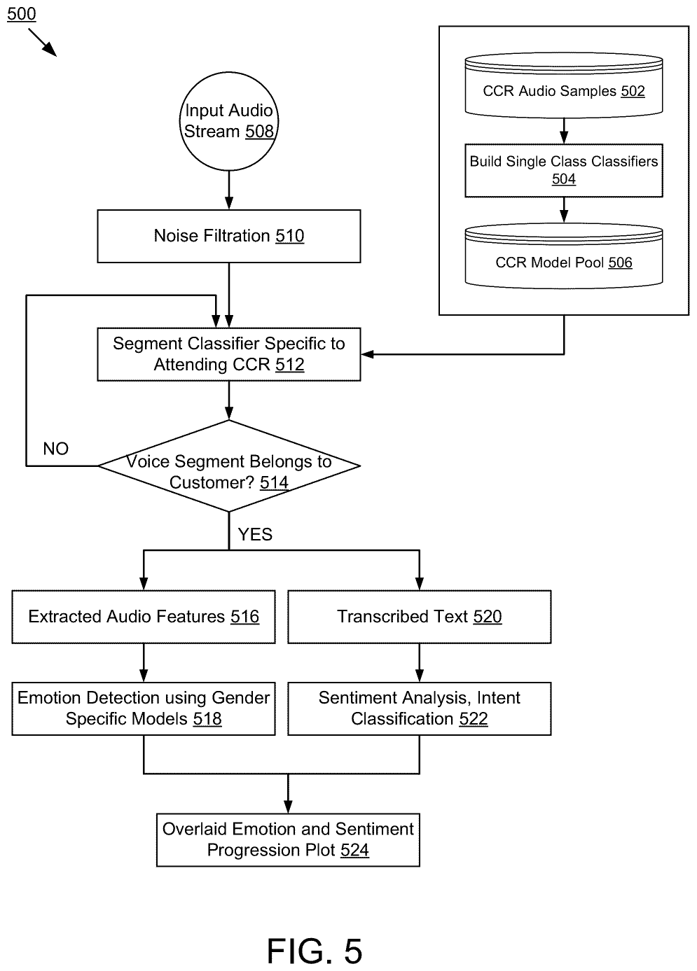

Contact center analytics system is another example application of the disclosed audio processing system. According to one embodiment, the contact center analytics system disclosed herein may intelligently create a pipeline 500 with an ensemble of speech analytics and text mining, as illustrated in FIG. 5.

Specifically, for an input audio stream 508, pipeline 500 may start with a noise filtration process 510 to remove certain noise included in the input audio stream 508. This may include the removal of any audio signal irrelevant to the customer-executive conversation. For example, certain Gaussian noise beyond the human audible frequency range may be first filtered out by using a frequency-based audio removal tool included in the disclosed contact center analytics system. Next, further refinement may be achieved by using a Recurrent Neural Network (RNN) based classification model or another different classification model. The classification model may be first trained with different types of noises, such as people talking in the background, traffic noise, weather related noise, etc. This then leaves the input audio stream 508 to merely include conversational segments from the customer and customer care executive for further processing.

Post noise removal, audio segmentation may be performed to extract the customer's and executive's speech segments separately to have separate and focused interpretations. This may improve the process of capturing sentiments (positive, negative, or neutral) and emotions (happy, angry, sad, or neutral) of the customer at different avenues of conversation without diluting it with the emotions of the executive. In some embodiments, the audio segmentation process may be achieved by first using the segmentation process as described earlier. The separated audio segments may be then subject to classification into customer audio segments and executive audio segments.

In some embodiments, unsupervised or supervised machine learning approaches may be used to separate the customer audio segments from the executive audio segments. In some embodiments, an ensemble approach consisting of both supervised and unsupervised methods may be employed to achieve higher accuracy. For example, a set of segment classifiers may be specifically trained for such purposes, as illustrated in step 512 in FIG. 5. That is, during the segmentation process, a classifier specific to the executive may be utilized for identifying audio segments belonging to the attending executive. The remaining segments may be determined to belong to the customer, which can be then used for sentiment and emotion analysis.

In some embodiments, the disclosed contact center analytics system may specifically configure a customer care representative (CCR) model pool 506, which may include a pool of segment classifiers specific to different CCRs in the contact center. These different segment classifiers may be utilized to identify the audio segments belonging to different executives within the customer care conversations or certain other conversations. As further illustrated in FIG. 5, to obtain a CCR model pool 506, the CCR audio samples 502 from all executives in the contact center may be utilized to build single class classifiers 504, which can be used to identify audio segments for each executive. In one example, the parameters of each specific classifier may be tuned or optimized to identify audio segments belonging to a specific executive but no other executives in the contact center.

In step 514, the intelligent pipeline 500 may then determine whether a voice segment belongs to a customer or not based on the outcome of the CCR-specific segment classifier. For example, audio segments that are not specific to the attending CCR may be considered audio segments from the customer included in the input audio stream 508. Post-extracting the customer's speech segments, emotion and sentiment analysis may be further performed to capture the customer's feelings during the customer service process.

Specifically, audio features may be extracted from the customer-specific audio segments (before voice-to-text conversion) at step 516, which may be utilized to detect the emotion of the customer using certain models (which may be gender-specific models) at step 518. Meanwhile, the text may be transcribed from the audio segments at step 520, which may be further utilized for sentiment analysis and/or intent classification 522.

In some embodiments, an ML classification engine (e.g., RNN-based emotion detection model) may be built for identifying gender-related motions by using male and female audio training samples covering different tones, accents, and emotions. Gender identification is a key step since male voices are usually lower-pitched. Accordingly, separate emotion detection models for both genders may be developed and utilized for emotion detection of the customer included in the input audio stream 508. In some embodiments, the disclosed contact center analytics system may keep track of the conversation and generate insights in real-time for each segment as the conversation between the customer and executive proceeds. The speech segments may be classified into “happy”, “neutral”, “angry” or “sad” using the fine-tuned RNN-based emotion detection model. In some embodiments, an emotion score may be used to indicate different types of emotions of the customer throughout the conversation, with a higher score indicating a better feeling of the customer at a moment. In some embodiments, the emotion score of the customer throughout the customer service process may be consistently tracked by using a series of points (e.g., a series of emotion scores), which may reflect the skill of the executive in handling the emotion of the customer.

In some embodiments, the sentiment classification into “positive”, “negative” or “neutral” may be also performed simultaneously using the extracted textual representation of speech (e.g., transcribed text 520 in FIG. 5) for each segment belonging to the customer. Accordingly, in some embodiments, another different sentiment ML classification engine configured for sentiment analysis may be also included in the disclosed contact center analytics system. In some embodiments, a sentiment score may be further generated by the sentiment ML classification engine, which may be used to gauge the customer's opinions of a company's service and products. A positive sentiment score indicates that customers are satisfied with their experience, while a negative score may reflect the opposite during the conversation with the executive.

In some embodiments, the disclosed contact center analytics system may further classify the transcribed text 520 into various intents of the customer's concern using one or more intent classification models included therein. For example, if it is an IT customer care setting, specific issues such as “hardware’ or “password retrieval” may be identified in real time from the text. Based on the identified intents, appropriate suggestions may be instantly and automatically retrieved from certain sources and provided (e.g., as a pop-up window) to the executive for resolving the issues more effectively. In this way, the disclosed contact center analytics system may equip executives with a tremendous amount of real-time feedback about the ongoing call, thereby improving the overall experience of the customers.

In some embodiments, both emotion, sentiment, and intention from the customer may be overlaid throughout the customer service process to generate an overlaid emotion and sentiment progression plot 524 throughout the process. By uncovering the emotional subtext behind the words and shedding light on customer sentiment, the disclosed contact center analytics system may facilitate the executive's refinement of the conversation, thereby improving service quality and the customer experience. In some embodiments, additional analysis may be also possible and contemplated by the disclosed contact center analytics system.

It should be noted that the above two example applications are provided merely for exemplary purposes, but not for limitations of the disclosure. For example, the disclosed audio processing application may be applied to claim-adjusting processes in the insurance industry, and so on.

### Implementing Device

In some embodiments, the various audio processing systems disclosed herein, such as the motorsports analytics system and the contact center analytics system described above, may be implemented on a computing system with access to a hard disk or remote storage, as further described in detail below.

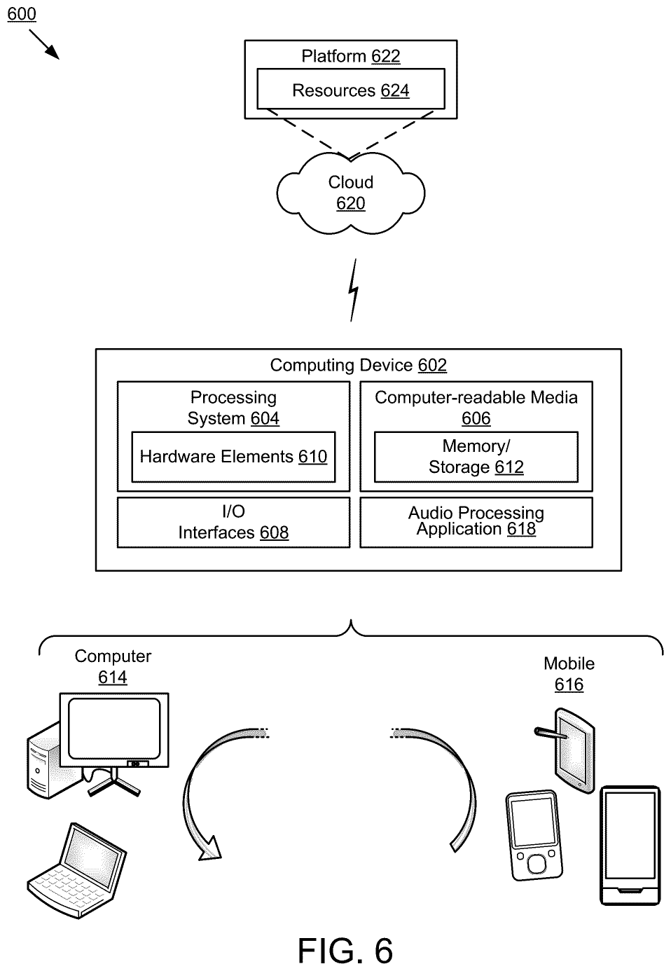

FIG. 6 illustrates an example system 600 that, generally, includes an example computing device 602 that is representative of one or more computing systems and/or devices that may implement the various techniques described herein. The computing device 602 may be, for example, an edge device 103, a cloud services unit 117, or an audio processing application server 101 as shown in FIG. 1, an on-chip system embedded in a device (e.g., IoT), and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of the functionality to perform one or more operations using hardware. Accordingly, the processing system 604 is illustrated as including hardware element 610 that may be configured as processors, functional blocks, and so forth. This may include implementation in hardware as an application-specific integrated circuit (ASIC) or other logic devices formed using one or more semiconductors. The hardware elements 610 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 606 is illustrated as including memory/storage 612. Memory/storage 612 represents memory/storage capacity associated with one or more computer-readable media. The memory/storage component 612 may include volatile media (such as random-access memory (RAM)) and/or nonvolatile media (such as read-only memory (ROM), Flash memory, optical disks, magnetic disks, and so forth). The memory/storage component 612 may include fixed media (e.g., RAM, ROM, a fixed hard drive, and so on) as well as removable media, e.g., Flash memory, a removable hard drive, an optical disc, and so forth. The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module.” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 610 and computer-readable media 606 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of an engine that is executable by the computing device 602 as software may be achieved at least partially in hardware, e.g., through the use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for providing one or more device-specific AI engines, which can be further personalized. This improves the performance of an AI engine not only due to its compatibility with specific device constraints but also due to its personalized output.

In the example system 600, multiple devices are interconnected through a central computing device. The central computing device may be local to multiple devices or may be located remotely from multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 602 may assume a variety of different configurations, such as for computer 614 and mobile 616 uses, and for many enterprise use, IoT user, and many other uses not illustrated in FIG. 6. Each of these configurations includes devices that may have generally different constructs and capabilities, and thus the computing device 602 may be configured according to one or more of the different device classes. For instance, the computing device 602 may be implemented as the computer 614 family of a device that includes a personal computer, desktop computer, multi-screen computer, laptop computer, netbook, and so on. The computing device 602 may also be implemented as the mobile 616 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 602 and are not limited to the specific examples of the techniques described herein. This is illustrated through the inclusion of an audio processing application 618 on the computing device 602, where the audio processing application 618 may include different units or engines as illustrated in FIGS. 1-2. The functionality represented by the audio processing application 618 and other modules/applications may also be implemented all or in part through the use of a distributed system, such as over a “cloud” 620 via a platform 622 as described below.

Cloud 620 includes and/or is representative of platform 622 for resources 624. Platform 622 abstracts the underlying functionality of hardware (e.g., servers) and software resources of the cloud 620. Resources 624 may include applications and/or data that can be utilized while computer processing is executed on servers that are remote from the computing device 602. Resources 624 can also include services provided over the internet and/or through a subscriber network, such as a cellular or Wi-Fi network.

Platform 622 may abstract resources and functions to connect the computing device 602 with other computing devices 614 or 616. Platform 622 may also serve to abstract the scaling of resources to provide a corresponding level of scale to encountered demand for the resources 624 that are implemented via platform 622. Accordingly, in an interconnected device implementation, the implementation functionality described herein may be distributed throughout system 600. For example, the functionality may be implemented in part on the computing device 602 as well as via platform 622 which abstracts the functionality of the cloud 620.

### ADDITIONAL CONSIDERATIONS

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method of processing an audio stream, comprising:
receiving an audio stream by a node;
splitting the audio stream into segments using a producer-consumer algorithm in a memory of the node, the audio stream being split into the segments based on silence detection;
transcribing voice included in a segment into text using a voice-to-text conversion engine; and
performing natural language processing on the text to identify situational insights from the segment.

2. The computer-implemented method of claim 1, wherein the audio stream is an HTTP live stream.

3. The computer-implemented method of claim 1, wherein splitting the audio stream into segments using a producer-consumer algorithm comprises:
creating a mediator buffer, a producer thread, and a consumer thread in the memory of the node;
enabling the producer thread to process one or more earliest portions of the audio stream as audio blocks and store the audio blocks in the mediator buffer; and
responsive to the mediator buffer being full, enabling the consumer thread to consume the audio blocks in the mediator buffer, wherein consuming the audio blocks comprises splitting each of one or more of the audio blocks into two or more segments, and wherein consuming each audio block in the mediator buffer causes the mediator buffer to have more free space.

4. The computer-implemented method of claim 3, further comprising:
responsive to the mediator buffer being emptied by the consumer thread, enabling the producer thread to process one or more updated earliest portions of the audio stream.

5. The computer-implemented method of claim 3, wherein a size of the mediator buffer is determined based on a bitrate of the audio stream.

6. The computer-implemented method of claim 3, wherein the consumer thread is disabled when the producer thread is enabled to process the one or more earliest portions of the audio stream and store the audio blocks in the mediator buffer.

7. The computer-implemented method of claim 3, wherein the producer thread is disabled when the consumer thread is enabled to consume the audio blocks in the mediator buffer.

8. The computer-implemented method of claim 3, wherein splitting the audio stream into segments based on silence detection comprises:
detecting a period of silence included in an audio block based on audio waves detected on the audio block;
comparing a time length of the period of silence to a predefined threshold; and
responsive to the time length of the period of silence being larger than the predefined threshold, determining that the period of silence is a place to split the audio block.

9. The computer-implemented method of claim 8, wherein detecting a period of silence included in an audio block comprises detecting multiple periods of silence in the audio block.

10. The computer-implemented method of claim 1, wherein, before transcribing the voice included in a segment, the method further comprises:
performing a padding process on the split segments

11. The computer-implemented method of claim 1, wherein, before transcribing the voice included in a segment, the method further comprises:
classifying a segment to a target user.

12. The computer-implemented method of claim 1, wherein, before transcribing the voice included in a segment, the method further comprises:
extracting audio features included in the segment, the segment belonging to a target user; and
detecting emotion of the user based on the extracted audio features.

13. The computer-implemented method of claim 1, wherein performing natural language processing on the text further comprises:
filtering out irrelevant information from the text.

14. The computer-implemented method of claim 1, wherein performing natural language processing on the text comprises:
performing a sentiment analysis of the text.

15. The computer-implemented method of claim 1, wherein performing natural language processing on the text comprises:
performing an intent classification of a target user based on the text.

16. The computer-implemented method of claim 1, further comprises:
publishing insights obtained from the segments using a pub/sub process.

17. The computer-implemented method of claim 1, wherein the audio stream comprises a plurality of channels of audio stream.

18. The computer-implemented method of claim 17, wherein splitting the audio stream into segments using a producer-consumer algorithm further comprises:
creating a worker architecture comprising a plurality of audio processing channel workers, wherein each audio processing channel worker implements a producer-consumer algorithm-based process to split one channel of audio stream.

19. The computer-implemented method of claim 18, wherein the worker architecture further comprises a plurality of content filtering workers, each content filtering worker implementing a content filtering process to remove noise or irrelevant information from the segments or text transcribed from the segments.

20. A system for processing an audio stream, comprising:
a processor; and
a memory, coupled to the processor, configured to store executable instructions that, when executed by the processor, cause the processor to perform operations including:
receiving an audio stream by a node;
splitting the audio stream into segments using a producer-consumer algorithm in a memory of the node, the audio stream being split into the segments based on silence detection;
transcribing voice included in a segment into text using a voice-to-text conversion engine; and
performing natural language processing on the text to identify situational insights from the segment.
